(19) United States
(12) Patent Application Publication
(10) Pub. No.: US 2024/0286730 A1
(43) Pub. Date: Aug. 29, 2024

(54) MORPHING WING, FLIGHT CONTROL DEVICE, FLIGHT CONTROL METHOD, AND PROGRAM

(71) Applicant: Japan Aerospace Exploration Agency, Tokyo (JP)

(72) Inventor: Daichi WADA, Chofu-shi (JP)

(21) Appl. No.: 18/575,216

(22) PCT Filed: Jul. 6, 2022
(86) PCT No.: PCT/JP2022/026789

§ 371 Date: Dec. 28, 2023

(30) Foreign Application Priority Data
Jul. 8, 2021 (JP) 2021-113444

(51) Int. Cl. B64C 3/54; G05D 1/654; G05D 101/15; G05D 109/22

(52) U.S. Cl. CPC B64C 3/546; G05D 1/654; B64C 2003/543; G05D 2101/15; G05D 2109/23

(57) ABSTRACT

A morphing wing (140) of the present invention includes a link mechanism configured to be deployed in a first direction and retracted in a second direction opposite to the first direction, a plurality of front wing covers (180) mounted on a front side which is one side of the link mechanism perpendicular to the first direction, and a plurality of flight feathers (160) mounted on a rear side which is the other side of the link mechanism perpendicular to the first direction, wherein the front wing covers (180) and the flight feathers (160) are streamlined from the front side toward the rear side, and when the link mechanism is retracted, the flight feathers (160) are retracted inside the adjacent flight feathers (160).

### TECHNICAL FIELD

The present invention relates to a morphing wing, a flight control device, a flight control method, and a program.

Priority is claimed on Japanese Patent Application No. 2021-113444, filed Jul. 8, 2021, the content of which is incorporated herein by reference.

### BACKGROUND ART

A morphing wing structure which can be deployed and retracted by a pantograph mechanism that is telescopic in a predetermined direction has been disclosed (for example, Patent Document 1).

There is morphing wing technology that greatly transforms an area and a shape of a wing in order to dramatically improve and expand flight performance (for example, Non-Patent Documents 1 and 2).

### CITATION LIST

### Patent Document

### Patent Document 1

Japanese Unexamined Patent Application, First Publication No. 2021-030950

### Non-Patent Document

### Non-Patent Document 1

Eric Chang, Laura Y. Matloff, Amanda K. Stowers, David Lentink, ‘Soft biohybrid morphing wings with feathers underactuated by wrist and finger motion’, [online]. 16 Jan. 2020, SCIENCE ROBOTICS, [Retrieved on 18 Jun. 2021]. <URL: https://robotics.sciencemag.org/content/5/38/eaay1246/tab-figures-data>

### Non-Patent Document 2

M. Di Luca, S. Mintchev, G. Heitz, F. Noca and D. Floreano, ‘Bioinspired morphing wings for extended flight envelope and roll control of small drones’, [online]. 6 Feb. 2017, INTERFACE FOCUS, [Retrieved on 18 Jun. 2021]. <URL: https://royalsocietypublishing.org/doi/10.1098/rsfs.2016.0092>

### SUMMARY OF INVENTION

### Technical Problem

The conventional morphing wing is designed with each of components having a flat shape, and the components simply overlap each other when the wing is deployed. In other words, there is a problem that the wing in a deployed state does not have a streamlined shape, and aerodynamic performance is greatly inferior to that of a wing shape of a known general airplane.

The present invention has been made in view of the circumstances described above, and an object thereof is to provide a morphing wing structure with high flight performance.

### Solution to Problem

In order to solve the above problems, the present invention proposes the following means.

A morphing wing according to the present invention includes a link mechanism configured to be deployed in a first direction and retracted in a second direction opposite to the first direction, a plurality of front wing covers mounted on a front side which is one side of the link mechanism perpendicular to the first direction, and a plurality of flight feathers mounted on a rear side which is the other side of the link mechanism perpendicular to the first direction, wherein the front wing covers and the flight feathers are streamlined from the front side toward the rear side, and when the link mechanism is retracted, the flight feathers are retracted inside the adjacent flight feathers.

According to the invention, the front wing covers and flight feathers are streamlined. Thus, aerodynamic performance can be improved, and a morphing wing with even better flight performance can be provided. Further, when the link mechanism is retracted, the flight feathers are retracted inside the adjacent flight feathers. Thus, the size of the morphing wing when the link mechanism is retracted can be minimized. Therefore, transportability can be further improved.

Further, the link mechanism may include a primary link including a front primary link mounted on the front side on the first direction side and a rear primary link mounted on the rear side on the first direction side, and a secondary link including a front secondary link mounted on the front side on the second direction side and a rear secondary link mounted on the rear side on the second direction side, and the plurality of flight feathers may be rotatably mounted on the front primary link and the rear primary link or the front secondary link and the rear secondary link, respectively.

According to the invention, the flight feathers are rotatably attached to the primary link and the connecting member or the front primary link and the rear primary link, respectively. Since one flight feather is mounted on two places in the link mechanism in this way, irregular movement of the flight feathers can be restricted by the link mechanism, and the position and orientation of the flight feathers can also be controlled by the link mechanism.

Also, the front wing covers may include a first front wing cover provided on the primary link, a second front wing cover provided on the secondary link, and a third front wing cover provided between the first front wing cover and the second front wing cover.

According to the invention, the first front wing cover provided on the primary link and the second front wing cover provided on the secondary link are included. Thus, the front wing cover can follow the deployment and retraction of the link mechanism. Further, the third front wing cover provided between the first front wing cover and the second front wing cover is provided. Thus, it is possible to prevent a gap from being formed in the front wing cover when the link mechanism is deployed. Therefore, it is possible to prevent the airflow around the morphing wings from being disturbed. Therefore, it is possible to contribute to improvement of the aerodynamic performance.

Also, the plurality of flight feathers may include a primary arm-wing mounted on the primary link and a secondary arm-wing mounted on the secondary link, and when the link mechanism is deployed, an angle formed between longitudinal directions of the adjacent flight feathers in the primary arm-wing may be as large as that formed between longitudinal directions of the flight feathers located in the first direction.

According to the invention, when the link mechanism is deployed, an angle formed by the longitudinal directions of the adjacent flight feathers in the primary arm-wing is as large as that formed by the longitudinal directions of the flight feathers located in the first direction. In other words, as the flight feathers are located closer to the second direction side, the angle formed between the longitudinal directions of the adjacent flight feathers becomes smaller. Thus, it is possible to prevent a decrease in the lift force caused by a gap between the flight feathers on the second direction side.

In addition, for the flight feathers located in the primary arm-wing, as the flight feathers are located closer to the first direction side, the angle between the longitudinal directions of the adjacent flight feathers becomes larger. Therefore, the flight feathers located at an end portion of the primary arm-wing on the first direction side are located in a direction in which the longitudinal directions thereof face the first direction side and the transverse directions face from the front toward the rear. Thus, the overall size of the morphing wing in the deployed state can be increased. Therefore, the lift force can be improved more.

Also, the flight feathers in the primary arm-wing may be configured so that an angle formed with the longitudinal directions of the adjacent flight feathers increases as the link mechanism is deployed.

According to the invention, the flight feathers in the primary arm-wing are configured so that an angle formed with the longitudinal directions of the adjacent flight feathers connected via the connecting member increases as the link mechanism is deployed. That is, when the link mechanism is retracted, an angle formed with the longitudinal directions of the adjacent flight feathers decreases. Thus, when the link mechanism is retracted, the primary arm-wing can be accommodated better. Therefore, it is possible to reduce the overall size of the morphing wing when retracted, which contributes to the improvement of portability.

Also, when the link mechanism is deployed, in the plurality of flight feathers located at an end portion on the first direction side, a transverse direction of each of the flight feather may face in a direction from the front side to the rear side, the transverse direction of each of the flight feathers may be streamlined from the front side to the rear side, and a gap may be provided between end portions of the rear side of the adjacent flight feathers.

According to the invention, when the link mechanism is deployed, the plurality of flight feathers located at the end portion on the first direction side are streamlined from the front toward the rear. Therefore, the maximum lift force can be ensured for the morphing wing in the deployed state. Furthermore, a gap is provided between the adjacent flight feathers. Thus, it is possible to curb the turbulence of the airflow generated at an end portion of the wing and to prevent stalling by allowing the airflow to escape through the gap. Therefore, it is possible to contribute to stable flight.

Also, the plurality of flight feathers located at the end portion on the first direction side may be elastically deformed.

According to the invention, the plurality of flight feathers located at the end portion on the first direction side are elastically deformed. Therefore, when the morphing wing is deployed, the plurality of flight feathers located at the end portion on the first direction side are deformed passively against a force exerted by the flow at the end portion of the morphing wing. Thus, it is possible to curb the turbulence in the airflow generated at the end portion of the wing. Therefore, it is possible to contribute to stable flight.

Further, a flight control device according to the present invention is a flight control device which controls a flight vehicle including the morphing wing, including a drive unit configured to extend and retract the link mechanism, and a control unit configured to control the drive unit, wherein the control unit controls the drive unit to extend the link mechanism in the first direction when the flight vehicle lands.

According to the invention, when the flight vehicle 100 lands, the control unit controls the drive unit to extend the link mechanism in the first direction. Thus, it is possible to ensure the lift force of the flight vehicle during landing and to contribute to stable landing.

Further, the control unit may acquire attitude information representing an attitude of the flight vehicle and may control the drive unit based on an output result of a model obtained by inputting the acquired attitude information to the model learned using deep reinforcement learning.

According to the invention, the deep reinforcement learning is used for flight control. Thus, it is possible to perform flight more efficiently and safely by performing the flight control according to the environment of the flight site.

Further, the control unit may acquire displacement information including at least one of deformation and pressure of the morphing wing and may control the drive unit based on an output result of the model obtained by inputting the acquired displacement information to the model.

According to the invention, the displacement information including at least one of deformation and pressure of the morphing wing is used for flight control. More agile control can be performed by acquiring the displacement information of the morphing wing and performing the control before the attitude of the flight vehicle changes. Therefore, it is possible to contribute to the improvement of mobility.

Further, a flight control method according to the present invention is a flight control method in which the flight control device that controls a flight vehicle having the morphing wing controls a drive unit that extends and retracts the link mechanism to extend the link mechanism when the flight vehicle lands.

According to the invention, when the flight vehicle lands, the drive unit that extends and retracts the link mechanism is controlled to extend the link mechanism. Thus, flying and landing closer to birds can be performed.

Further, a program according to the present invention is a program which causes the flight control device that controls a flight vehicle having the morphing wing to extend the link mechanism by controlling a drive unit that extends and retracts the link mechanism when the flight vehicle lands.

### Advantageous Effects of Invention

According to the present invention, a morphing wing structure with high flight performance can be provided.

### BRIEF DESCRIPTION OF DRAWINGS

FIG. 1 is a diagram showing an example of a configuration of a flight vehicle equipped with a morphing wing and a flight control device according to a first embodiment.

FIG. 2 is a diagram showing an example of a configuration of the morphing wing according to the first embodiment.

FIG. 3 is a diagram showing a retracted state of the morphing wing.

FIG. 4 is a diagram showing a deployed state of the morphing wing.

FIG. 5 is a diagram showing a state in which flight feathers are retracted inside adjacent flight feathers when the morphing wing is retracted.

FIG. 6 is an overall view of a flight feather.

FIG. 7 is an overall view of a flight feather located at an end portion of the morphing wing.

FIG. 8 is a diagram showing a mounting state between a link mechanism and flight feathers.

FIG. 9 is an overall view of a front wing cover.

FIG. 10 is a diagram for describing a sweep operation of the morphing wing.

FIG. 11 is a diagram for describing a twisting operation of the morphing wing.

FIG. 12 is a diagram showing an example of a configuration of the flight control device of the first embodiment.

FIG. 13 is a diagram showing an example of an attitude control system using quaternion feedback.

FIG. 14 is a flowchart showing a flow of a series of processes of a control unit.

FIG. 15 is a diagram schematically showing a state in which a flight vehicle flies.

FIG. 16 is a diagram showing an example of a configuration of a flight control device of a second example of control.

### DESCRIPTION OF EMBODIMENTS

Hereinafter, embodiments of a morphing wing, a flight control device, a flight control method, and a program according to the present invention will be described with reference to the drawings.

### First Embodiment

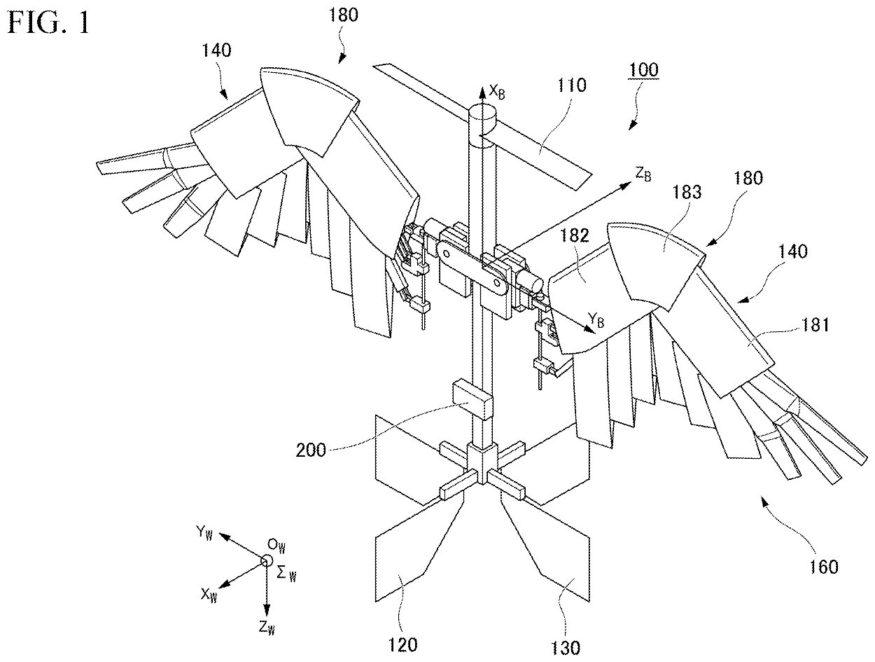

FIG. 1 is a diagram showing an example of a configuration of a flight vehicle 100 including a morphing wing 140 and a flight control device 200 according to a first embodiment. The flight vehicle 100 imitates a bird and includes, for example, a propeller 110, a vertical tail 120, a horizontal tail 130, a morphing wing 140, and a flight control device 200.

Σ_{W} shown in the drawing represents one earth-fixed coordinate Σ_{W} of the inertial coordinate system, O_{W} represents the origin of the earth-fixed coordinate Σ_{W}, an X_{W} axis represents true north, a Y_{W} axis represents east, and a Z_{W} axis represents a vertically downward direction. Further, when the principal axis of inertia is defined as a fuselage-fixed coordinate system of the flight vehicle 100, in the drawing, an X_{B} axis represents a principal axis of inertia of a fuselage when the center of gravity of the flight vehicle 100 is taken as the origin, a Z_{B} axis represents a downward direction of the fuselage, and a Y_{B} axis represents a rightward direction in a traveling direction of the fuselage. In other words, the X_{B} axis represents a roll axis X_{B}, the Z_{B} axis represents a yaw axis Z_{B}, and the Y_{B} axis represents a pitch axis Y_{B}.

The propeller 110 is provided, for example, at a tip end of the fuselage of the flight vehicle 100, and is mounted to be rotatable around an axis of the fuselage (around the X_{B} axis in the drawing).

The vertical tail 120 and the horizontal tail 130 are provided at a position away from the center of gravity of the flight vehicle 100, such as the terminal of the flight vehicle 100, for example.

The morphing wings 140 are provided on both left and right sides of the fuselage of the flight vehicle 100. Each of the morphing wings 140 includes a sweep mechanism, a twist mechanism, and a link mechanism. The sweep mechanism is a mechanism for rotating the morphing wings 140 around the yaw axis Z_{B}. The twist mechanism is a mechanism for rotating the morphing wings 140 around the pitch axis Y_{B}.

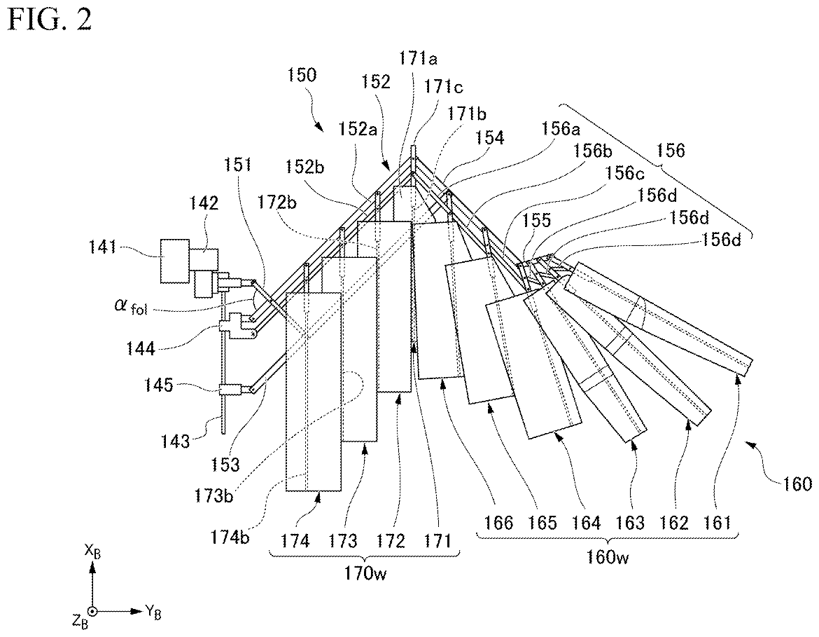

The link mechanism is a mechanism for folding and deploying the morphing wings 140 with respect to the direction of the pitch axis Y_{B}. That is, in the morphing wings 140, the link mechanism is a mechanism that enables deployment in a first direction which is a positive direction of the pitch axis Y_{B} shown in FIG. 2 and retraction in a direction opposite to the first direction, that is, a second direction that is a negative direction of the pitch axis Y_{B}.

FIG. 2 shows details of a configuration of the morphing wing 140 provided on the right side of the flight vehicle 100 shown in FIG. 1. The relationship between the first direction and the second direction is reversed for the morphing wing 140 provided on the left side of the flight vehicle 100 shown in FIG. 1. That is, in the morphing wing 140 provided on the left side of the flight vehicle 100 shown in FIG. 1, the negative direction of the pitch axis Y_{B} is the first direction, and the positive direction of the pitch axis Y_{B} is the second direction.

The flight control device 200 controls the propeller 110, the vertical tail 120, the horizontal tail 130, and the morphing wings 140 to cause the flight vehicle 100 to take off, land, turn during flight, and descend while hovering.

### [Configuration of Morphing Wing 140]

The configuration of the morphing wing 140 will be described below. FIGS. 1 and 2 are diagrams showing an example of the configuration of the morphing wing 140 of the first embodiment. The morphing wing 140 includes, for example, a yaw axis rotating member 141, a pitch axis rotating member 142, a rail member 143, a first slider 144, a second slider 145, a link unit 150, a flight feather 160, and a front wing cover 180.

The yaw axis rotating member 141 and the pitch axis rotating member 142 connect the morphing wing 140 and the fuselage of the flight vehicle 100 to each other. The yaw axis rotating member 141 rotates around the yaw axis Z_{B}. The pitch axis rotating member 142 rotates around the pitch axis Y_{B}.

The rail member 143 is mounted on the fuselage of the flight vehicle 100 via the yaw axis rotating member 141 and the pitch axis rotating member 142 so that a longitudinal direction thereof is substantially parallel to the roll axis X_{B}.

The first slider 144 is mounted on the rail member 143. The first slider 144 slides on the rail member 143 in the longitudinal direction of the rail member 143, that is, in the direction of the roll axis X_{B}.

The second slider 145 is mounted on the rail member 143. The second slider 145 slides on the rail member 143 in the longitudinal direction of the rail member 143, that is, in the direction of the roll axis X_{B}.

The link mechanism described above is a combination of the rail member 143, the first slider 144, the second slider 145 and the link unit 150.

The link unit 150 is operated by the first slider 144 and the second slider 145. A plurality of flight feathers 160 are provided in the link unit 150. The link unit 150 includes a first link 151, a secondary link 152, a second link 153, a front primary link 154, a wing tip link 155, and a connecting member 156 (a rear primary link).

One end of the first link 151 is mounted on the pitch axis rotating member 142 so as to be rotatable around the yaw axis Z_{B}, and the other end of the first link 151 is mounted on one place between both end portions of the second link 153 so as to be rotatable around the yaw axis Z_{B}. One place between both end portions of the first link 151 is mounted on one place between both end portions of the front secondary link 152a so as to be rotatable around the yaw axis Z_{B}.

The secondary link 152 located on the second direction side of the link unit 150. The secondary link 152 includes the front secondary link 152a and a rear secondary link 152b located parallel to each other.

The front secondary link 152a and the rear secondary link 152b cross the first link 151. As shown in FIG. 2, the front secondary link 152a and the rear secondary link 152b are provided in parallel, and one end of each of them is mounted on the first slider 144 so as to be rotatable around the yaw axis Z_{B}, and the other end is mounted on one end of the front primary link 154 so as to be rotatable around the yaw axis Z_{B}.

The front secondary link 152a is located on the front side which is one side orthogonal to the first direction, that is, on the side in the positive direction of the X_{B} axis which is a traveling direction of the flight vehicle 100, and the rear secondary link 152b is located on the rear side which is the other side orthogonal to the first direction. Also, there is a difference in that the first link 151 is rotatably mounted on the front secondary link 152a and is not mounted the rear secondary link 152b.

One end of the second link 153 is mounted on the second slider 145 so as to be rotatable around the pitch axis Y_{B} to be parallel to the secondary link 152, and the other end is mounted on one place between both ends of the front primary link 154 so as to be rotatable around the pitch axis Y_{B}.

The front primary link 154 is located forward of the link unit 150 in the first direction. One end of the front primary link 154 is mounted on the other end of the front secondary link 152a so as to be rotatable around the yaw axis Z_{B}, and the other end is mounted on one end of the wing tip link 155.

The wing tip link 155 is mounted on the other end of the front primary link 154. A wing tip blade is mounted on the wing tip link 155 (which will be described below).

Mounting positions of the first link 151 and the front secondary link 152a, mounting positions of the second link 153 and the first link 151, and mounting positions of the second link 153 and the front primary link 154 are determined by appropriately considering an amount of sliding of the first slider 144 and the second slider 145 in the link unit 150 and a movement margin required for deployment and retraction in the link unit 150.

A plurality of connecting members 156 are provided behind the front primary link 154 in a longitudinal direction of front primary link 154. Each of the connecting member 156 includes a first connecting member 156a, a second connecting member 156b, a third connecting member 156c, and a fourth connecting member 156d.

The connecting members 156 are provided between a plurality of flight feathers 160 behind the front primary link 154. Specifically, the first connecting member 156a is provided between a first secondary flight feather 171 and a sixth primary flight feather 166. The second connecting member 156b is provided between the sixth primary flight feather 166 and a fifth primary flight feather 165. The third connecting member 156c is provided between the fifth primary flight feather 165 and a fourth primary flight feather 164. The fourth connecting member 156d is provided between the fourth primary flight feather 164 and a third primary flight feather 163, between the third primary flight feather 163 and a second primary flight feather 162, and between the second primary flight feather 162 and a first primary flight feather 161.

Each component of the link unit 150 preferably has high rigidity and strength and light weight. For example, it is preferably made of CFRP, aluminum, or plastic.

The above-described front primary link 154 and connecting member 156 may be collectively referred to as a primary link.

A plurality of flight feathers 160 are mounted on the rear side of the link unit 150. Each of the flight feathers 160 is a sheet-shaped member (having a thickness of several hundred μm, for example) that allows a certain amount of deflection, such as carbon fiber reinforced plastic (CFRP).

An exterior of the plurality of flight feathers 160 is common in that they are all streamlined from the front to the rear. Hereinafter, the components of the flight feather 160 will be described by taking the first secondary flight feather 171 as an example. Except for the detailed shape and the matters specifically described, the schematic configuration of each of the plurality of flight feathers 160 is the same in that it includes at least a main body, a reinforcing member, and a mounting member.

The first secondary flight feather 171 includes a main body 171a, a reinforcing material 171b, and a mounting member 171c. The main body 171a forms an exterior of the first secondary flight feather 171. The function of the first secondary flight feather 171 is ensured by streamlining the main body 171a. The main body 171a is formed of CFRP having a curvature, for example. The flight feathers 160 are open toward the front and both sides in the longitudinal direction, as shown in FIG. 6, by being formed in this manner.

The reinforcing material 171b is provided in a gap between materials in the main body 171a. Thus, the main body 171a is reinforced. For the reinforcing material 171b, for example, a balsa material or plastic is preferably used. When plastic is used, it may be formed by a 3D printer.

The mounting member 171c is connected to the reinforcing material 171b and used to mount the main body 171a on the link unit 150. Specifically, as shown in FIG. 8, the mounting member 171c is formed so as to sandwich the link unit 150 from above and below. In this state, the mounting member 171c and the link unit 150 are rotatably connected by a pin or the like. It is assumed that this fixing method is the same for any rotatable fixing part of the link unit 150.

The plurality of flight feathers 160 are classified into a primary arm-wing 160w and a secondary arm-wing 170w.

The primary arm-wing 160w is that mounted on the front primary link 154 among the plurality of flight feathers 160. In this embodiment, the primary arm-wing 160w includes a first primary flight feather 161, a second primary flight feather 162, a third primary flight feather 163, a fourth primary flight feather 164, a fifth primary flight feather 165, and a sixth primary flight feather 166. The plurality of flight feathers 160 in the primary arm-wing 160w are rotatably mounted on each of the front primary link 154 and the connecting member 156. Hereinafter, in the primary arm-wing 160w, the first primary flight feather 161, the second primary flight feather 162, and the third primary flight feather 163 may be collectively referred to as wing tip blades.

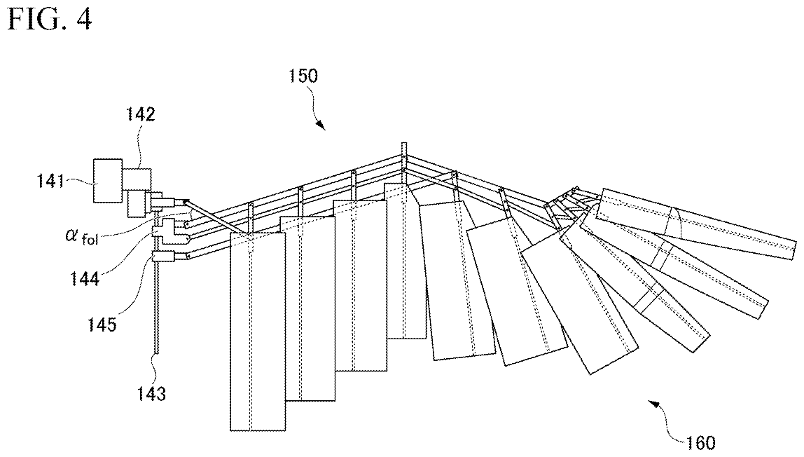

As shown in FIG. 4, in the morphing wing 140 with the link mechanism deployed, an angle formed by the longitudinal directions of the flight feathers 160 adjacent to each other in the primary arm-wing 160w is as large as that between the longitudinal directions of the flight feathers 160 located in the first direction. The flight feathers 160 in the primary arm-wing 160w are configured so that an angle formed by the longitudinal direction of the adjacent flight feathers 160 connected via the connecting member 156 increases as the link unit 150 is deployed (which will be described below). Thus, the primary arm-wing 160w has a gap between rear ends of the adjacent flight feathers 160. The gap refers to a region in which the adjacent flight feathers 160 are not located in plan view shown in FIG. 4. The angle here is an angle on an X_{B}-Y_{B} plane and does not include an angular component around the Z_{B} axis.

Thus, it has the same structure as a primary arm-wing that a bird has. The primary arm-wing of a bird allows airflow to flow through gaps between adjacent flight feathers as described above. Thus, it has the role of curbing stall.

The wing tip blades and the other flight feathers 160 in the primary arm-wing 160w are different in the following points. That is, as shown in FIG. 4, when the link unit 150 is deployed, the longitudinal direction of the other flight feathers 160 is located from the front toward the rear, while transverse direction of the wing tip blades is located from the front toward the rear.

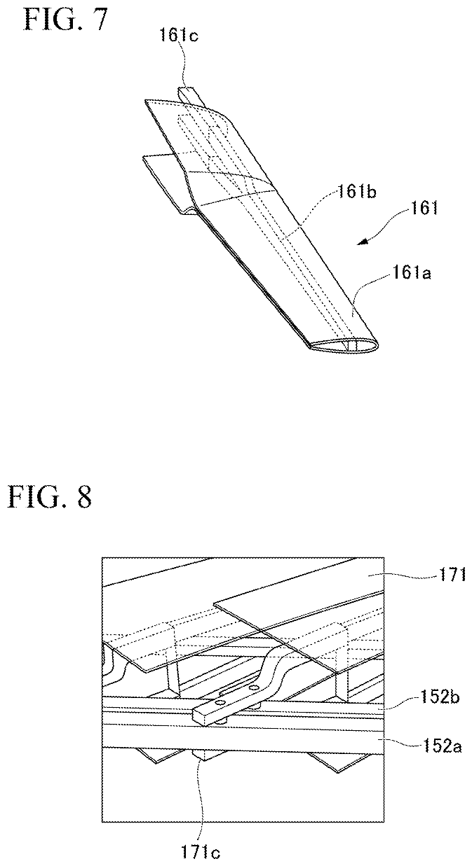

Thus, while the other flight feathers 160 are streamlined in the longitudinal direction as shown in FIG. 6, the flight feathers 160 forming the wing tip blades are streamlined in the transverse direction as shown in FIG. 7. Thus, it contributes to curb of stall at the wing tip of the morphing wing 140.

In addition to allowing the airflow to flow through the gaps formed as described above, the flight feathers 160 of the wing tip blades may be elastically deformed. In other words, the flight feathers 160 on the wing tip blades may be passively elastically deformed according to the airflow to reduce flow disturbances that occur at an end of the morphing wing 140. In order to make the flight feathers 160 of the wing tip blades elastically deformable, for example, only the flight feathers 160 of the wing tip blades may be made of an elastic material, or the flight feathers 160 may be creased as shown in FIG. 7 to facilitate deformation.

The secondary arm-wing 170w is some of the plurality of flight feathers 160 mounted on the secondary link 152. In this embodiment, the secondary arm-wing 170w includes the first secondary flight feather 171, a second secondary flight feather 172, a third secondary flight feathers 173, and a fourth secondary flight feathers 174. The plurality of flight feathers 160 in the secondary arm-wing 170w are rotatably mounted on each of the front secondary link 152a and the rear secondary link 152b.

The flight feathers 160 adjacent to each other in the secondary arm-wing 170w are all parallel in the longitudinal direction. As shown in FIGS. 2, 3, and 4, the flight feathers 160 in the primary arm-wing 160w are located substantially parallel to the adjacent flight feathers 160. The angle here is an angle on an X_{B}-Y_{B} plane and does not include an angular component around the Z_{B} axis.

Next, a description will be given of a mounting structure of the primary arm-wing 160w and the secondary arm-wing 170w in the link unit 150, and the movement of the flight feathers 160 due to the deployment and retraction of the link unit 150.

First, the flight feathers 160 constituting the secondary arm-wing 170w will be described with reference to the first secondary flight feather 171. As shown in FIG. 6, the mounting member 171c is mounted on the front secondary link 152a and the rear secondary link 152b so as to be rotatable around the pitch axis Y_{B}. At this time, a length of a straight line between two mounting points on the mounting member 171c is equal to a length of a straight line between mounting points of the first slider 144 and the front and rear secondary links 152a and 152b. Also, the two straight lines described above are mounted so as to be parallel. The second secondary flight feather 172, the third secondary flight feather 173, and the fourth secondary flight feather 174 are similarly mounted.

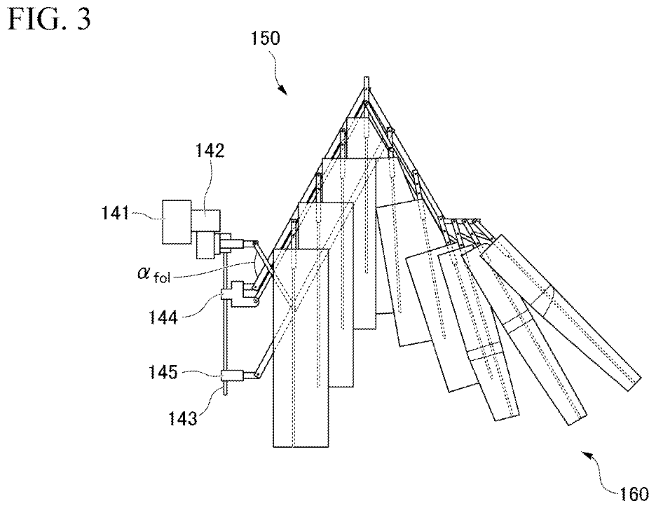

Thus, in the secondary arm-wing 170w, components thereof form a parallelogram. Thus, even when an angle of the secondary link 152 changes in the link unit 150, the direction of the flight feathers 160 remains constant. Therefore, as shown in FIGS. 3 and 4, even when the first slider 144 moves and the angle of the secondary link 152 changes, all the flight feathers 160 constituting the secondary arm-wing 170w always face in a direction in which the longitudinal direction is located from the front toward the rear. Therefore, as described above, the flight feathers 160 in the secondary arm-wing 170w are always located substantially parallel to the adjacent flight feathers 160.

Next, the flight feathers 160 constituting the primary arm-wing 160w will be described. The primary link on which the primary arm-wing 160w is mounted is different from the secondary link 152 constituting the secondary arm-wing 170w in the following points. That is, while the secondary link 152 is configured of the front secondary link 152a and the rear secondary link 152b provided in parallel, in the front primary link 154, the connecting member 156 is provided at a portion corresponding to the rear secondary link 152b.

As shown in FIG. 2, the connecting members 156 located between adjacent flight feathers 160 have different lengths. Also, the lengths between mounting points are different.

As described above, in the secondary arm-wing 170w, the components form a parallelogram. On the other hand, in the primary arm-wing 160w, the connecting members 156 are used to appropriately adjust the length between the mounting points so as not to form a parallelogram. Thus, as the angles of the front primary link 154 and the connecting members 156 are changed by the link unit 150, the angles of the flight feather 160 are changed.

For example, a length of the first connecting member 156a is longer than the length of the straight line between the mounting points of the front primary link 154 and the first secondary flight feather 171 and the sixth primary flight feather 166. Furthermore, the length of the straight line between the mounting points of the sixth primary flight feather 166 and the front primary link 154 and the first connecting member 156a is longer than the length of the straight line between the mounting points of the first secondary flight feather 171 and the front primary link 154 and the first connecting member 156a.

Thus, as shown in FIG. 4, when the link unit 150 is deployed and an angle between the mounting member 171c of the first secondary flight feather 171 and the front primary link 154 becomes close to a right angle, the mounting point between the sixth primary flight feather 166 and the first connecting member 156a is located on the first direction side of the mounting point between the sixth primary flight feather 166 and the front primary link 154. Therefore, the sixth primary flight feather 166 forms an angle with respect to the first primary flight feather 161 located nearby.

Like the second connecting member 156b between the sixth primary flight feather 166 and the fifth primary flight feather 165, and the third connecting member 156c between the fifth primary flight feather 165 and the fourth primary flight feather 164, the relationship is made more conspicuous as it is located in the first direction. Thus, as described above, a gap between the flight feathers 160 in the primary arm-wing 160w and the longitudinal direction of the adjacent flight feathers 160 connected via the connecting member 156 becomes large as the link unit 150 is deployed.

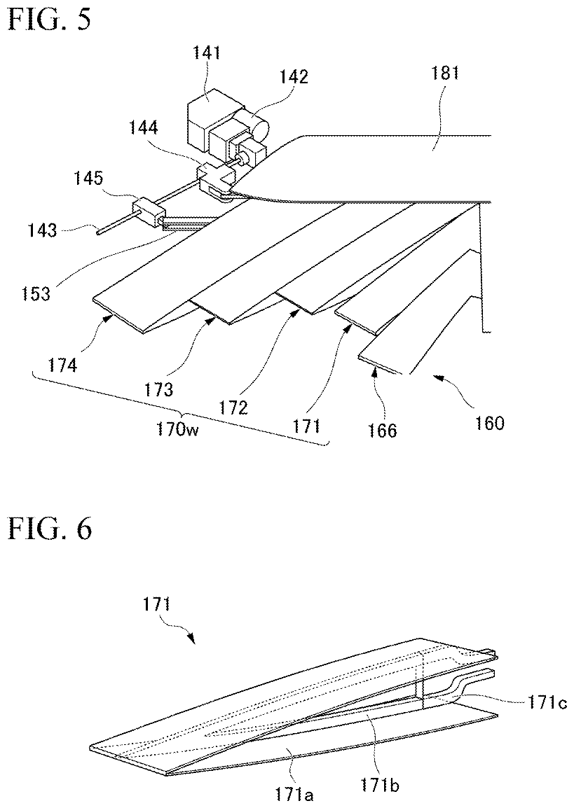

The plurality of flight feathers 160 provided in the primary arm-wing 160w other than the wing tip blades and in the secondary arm-wing 170w are arranged as follows according to the deployment and retraction of the link unit 150. That is, as shown in FIG. 5, when the link unit 150 is retracted, one wing tip blade is retracted inside the adjacent wing tip blade. Thus, when the link unit 150 is retracted, the size of the morphing wing 140 when retracted is reduced, contributing to improved transportability, in addition to preventing the adjacent flight feathers 160 from interfering with each other.

In order to ensure the above function, the size of each of the flight feathers 160 is determined by appropriately considering positions and sizes of the adjacent flight feathers 160 when the link unit 150 is retracted. Further, as shown in FIG. 5, when the link unit 150 is retracted, the second link 153 is located inside the flight feathers 160 of the secondary arm-wing 170w. Therefore, in order to prevent interference with the second link 153, a notch is provided in the reinforcing material 171b, as shown in FIG. 6. Similarly, the notch is also provided in each of the reinforcing members 172b, 173b, and 174b.

In this embodiment, a total of ten flight feathers 160 including the primary arm-wing 160w and the secondary arm-wing 170w are provided, but the number of flight feathers 160 is not limited thereto. That is, the number and size of the flight feathers 160 may be increased or decreased as necessary after considering a weight of the flight vehicle 100 and environment in which the flight vehicle 100 is used.

The front wing cover 180 is mounted in front of the link unit 150. The front wing cover 180 prevents air from flowing into forward facing openings of the flight feathers 160 in the deployed morphing wing 140. In addition, the front wing cover 180 is streamlined from the front toward the rear. Thus, the morphing wing 140 as a whole is streamlined.

The front wing cover 180 includes a first front wing cover 181, a second front wing cover 182 and a third front wing cover 183. The first front wing cover 181 is provided on the front primary link 154. The second front wing cover 182 is provided on the secondary link 152. The third front wing cover 183 is provided between the first front wing cover 181 and the second front wing cover 182.

Hereinafter, components of the front wing cover 180 will be described by taking the first front wing cover 181 as an example. The components of the front wing cover 180, which are provided in plurality, are all the same, except for a detailed shape and particulars described.

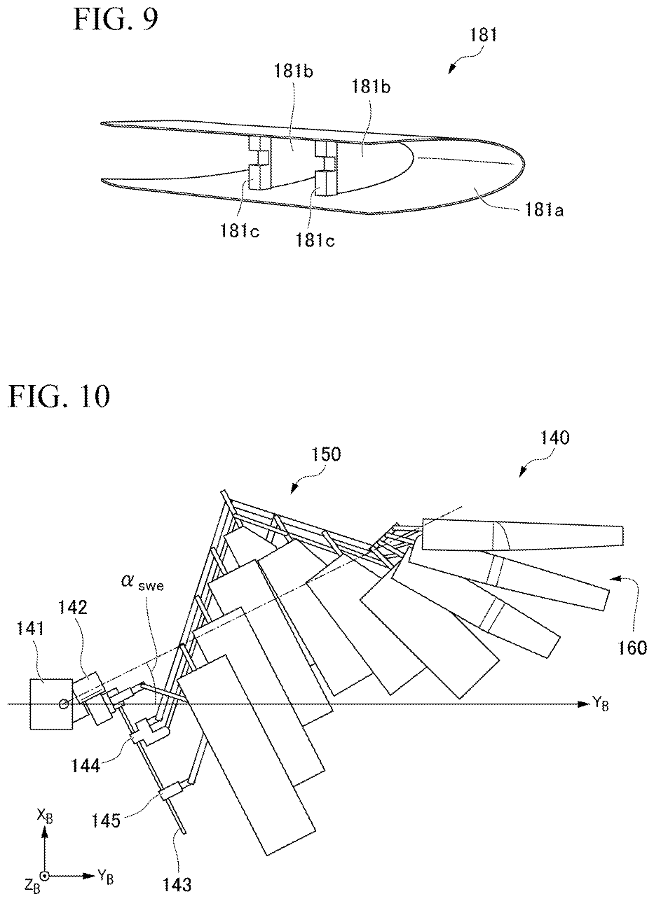

The first front wing cover 181 includes a main body 181a, a reinforcing part 181b, and a mounting part 181c. The main body 181a forms an exterior of the first front wing cover 181. The function of the first front wing cover 181 is ensured by the main body 181a being streamlined. The main body 181a is made of CFRP having a curvature, for example. The front wing cover 180 opens rearward by being formed in this way, as shown in FIG. 9.

The reinforcing part 181b is provided in a gap between materials of the main body 181a. Thus, the main body 181a is reinforced. A balsa material or plastic, for example, is preferably used for the reinforcing part 181b. When plastic is used, it may be formed by a 3D printer.

The mounting part 181c is connected to the reinforcement portion 181b and used to attach the main body 181a to the link unit 150. Specifically, the mounting parts 181c are formed so as to sandwich the front primary link 154 in a vertical direction. In this state, the mounting part 181c and the link unit 150 are connected. This fixing method is the same for the second front wing cover 182 and the third front wing cover 183 as well.

The first front wing cover 181 is mounted on the front secondary link 152a of the link unit 150. The second front wing cover 182 is mounted on the front primary link 154 of the link unit 150. The third front wing cover 183 is mounted on the first secondary flight feather 171. Thus, the front wing cover 180 moves following the deployment and retraction of the link unit 150.

FIG. 10 is a diagram for describing a sweep operation of the morphing wing 140. The sweep operation is an operation of rotating the morphing wing 140 around the yaw axis Z_{B} and moving the morphing wing 140 forward and backward of the flight vehicle 100. An angle formed between the morphing wing 140 and the pitch axis Y_{B} when the morphing wing 140 is rotated around the yaw axis Z_{B} is called a “sweep angle α_{swe}.”

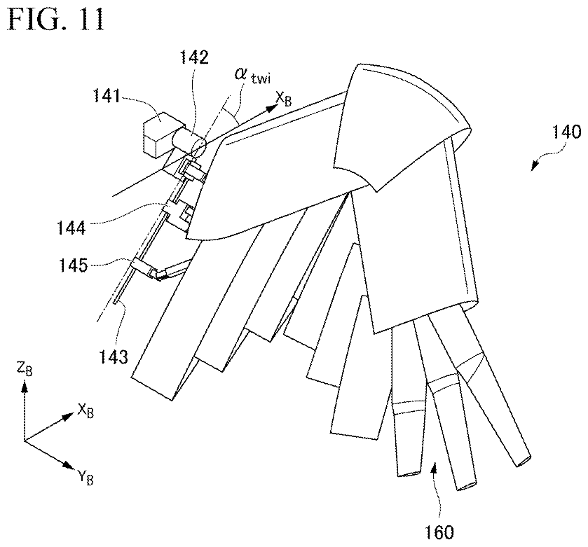

FIG. 11 is a diagram for describing a twist operation of the morphing wing 140. The twist operation is an operation of rotating the morphing wing 140 around the pitch axis Y_{B} to rotate the morphing wing 140 inward or outward with respect to the flight vehicle 100. An angle formed between the morphing wing 140 and the roll axis X_{B} when the morphing wing 140 is rotated around the pitch axis Y_{B} is referred to as a “twist angle α_{twi}.”

FIGS. 2, 3, and 4 are diagrams for explaining a fold operation of the morphing wings 140. The fold operation is an operation of extending the morphing wing 140 in the direction of the pitch axis Y_{B} like a pantograph to expand the morphing wing 140, or to retract the morphing wing 140 in the direction of the pitch axis Y_{B} like a pantograph to fold the morphing wing 140. An angle formed between the first link 151 and the front secondary link 152a when the morphing wing 140 is expanded and retracted in the direction of the pitch axis Y_{B} is referred to as a “fold angle α_{fol}.”

In the example of FIG. 3, the second slider 145 is located at an end of the rail member 143 (an end on the side opposite to a position in which the pitch axis rotating member 142 is mounted). In this case, the fold angle α_{fol} takes the maximum angle within a possible angle range. Thus, the morphing wing 140 is maximally folded.

In the example of FIG. 2, the second slider 145 is moving from the end of the rail member 143 to an end on the pitch axis rotating member 142 side. In this case, since the fold angle α_{fol} is smaller than the angle illustrated in FIG. 3, the morphing wing 140 is in a more open state than the state illustrated in FIG. 3.

In the example of FIG. 4, the second slider 145 has moved to the maximum extent to the end on the pitch axis rotating member 142 side. In this case, the fold angle α_{fol} takes the smallest angle with the possible angle range. Thus, the morphing wing 140 is in the maximum open state.

As the first slider 144 moves on the rail member 143 in this way, the morphing wing 140 is folded or opened.

In general, when it is difficult for the wing of the flight vehicle to catch the wind (when the wind is weak), or when an angle of attack of the wing upon landing of the flight vehicle is increased, it is known that a phenomenon called boundary layer separation, in which the airflow flowing on a surface of the wing separates, causes the flight vehicle to stall.

In this embodiment, since a gap is formed between the flight feathers 160, even when it is difficult for the morphing wing 140 to catch the wind or when the angle of attack of the morphing wing 140 is increased, it is possible to curb occurrence of the boundary layer separation. As a result, it is possible to fly stably while a rapid decrease in a lift force is curbed. That is, since a gap is formed between the flight feathers 160, the airflow can escape to the gap even when flying at a large angle of attack, and thus stall can be curbed.

### [Configuration of Flight Control Device]

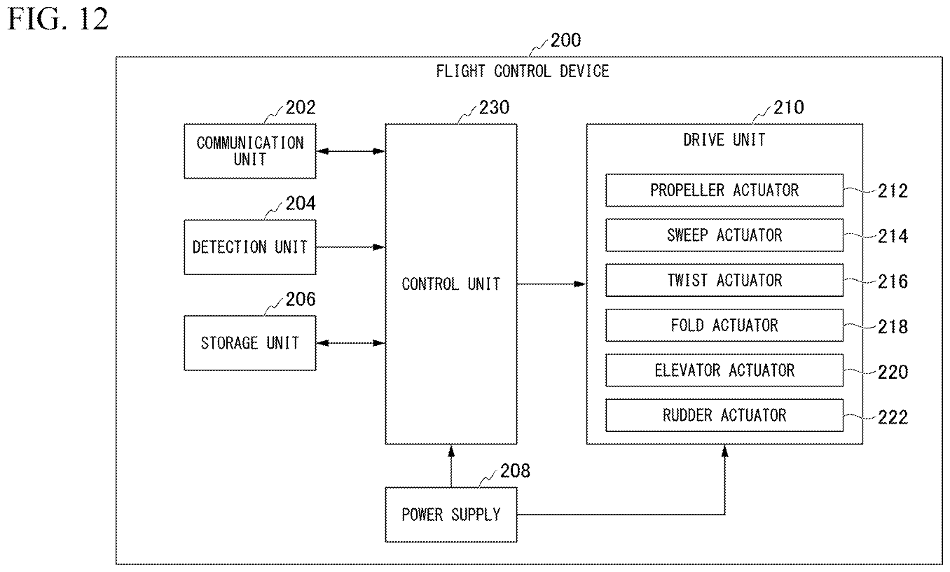

A configuration of the flight control device 200 will be described below. FIG. 12 is a diagram showing an example of the configuration of the flight control device 200 according to the first embodiment. The flight control device 200 includes, for example, a communication unit 202, a detection unit 204, a storage unit 206, a power supply 208, a drive unit 210, and a control unit 230.

The communication unit 202 performs wireless communication with an external device via a network such as a wide area network (WAN), for example. The external device may be, for example, a remote controller capable of remotely controlling the flight vehicle 100. For example, the communication unit 202 receives a command that instructs an attitude, a speed, and the like that the flight vehicle 100 should take from the external device.

The detection unit 204 is, for example, an inertial measurement device. The inertial measurement device includes, for example, a triaxial acceleration sensor and a triaxial gyro sensor. The inertial measurement device outputs detection values detected by the sensors to the control unit 230. The detection values detected by the inertial measurement device include, for example, accelerations and/or angular velocities in the horizontal, vertical, and depth directions, and velocities (rates) in the pitch, roll, and yaw axes. The detection unit 204 may further include a radar, a finder, a sonar, a global positioning system (GPS) receiver, and the like. Moreover, the detection unit 204 may further include an optical fiber sensor that detects the deformation of the vertical tail 120, the horizontal tail 130, and the morphing wing 140, and a pressure sensor that detects the pressure applied to the wings.

The storage unit 206 is implemented by a storage device such as a hard disc drive (HDD), a flash memory, an electrically erasable programmable read only memory (EEPROM), a read only memory (ROM), a random access memory (RAM), or the like. The storage unit 206 stores calculation results of the control unit 230 as logs, in addition to various programs such as firmware and application programs.

The power supply 208 is, for example, a secondary battery such as a lithium ion battery. The power supply 208 supplies power to the drive unit 210 and the control unit 230. The power supply 208 may also include solar panels and the like.

The drive unit 210 includes, for example, a propeller actuator 212, a sweep actuator 214, a twist actuator 216, a fold actuator 218, an elevator actuator 220 and a rudder actuator 222. The actuators may be, for example, servomotors.

The propeller actuator 212 drives the propeller 110 to give thrust to the flight vehicle 100. The sweep actuator 214 drives the yaw axis rotating member 141 to rotate the morphing wing 140 around the yaw axis Z_{B}.

The twist actuator 216 drives the pitch axis rotating member 142 to rotate the morphing wing 140 around the pitch axis Y_{B}. The fold actuator 218 drives the first slider 144 mounted on the rail member 143 in the direction of the roll axis X_{B} to deploy or fold the morphing wing 140 in the direction of the pitch axis Y_{B}.

The elevator actuator 220 drives an elevator (not shown) provided in the horizontal tail 130 to raise or lower the nose. The rudder actuator 222 drives a rudder (not shown) provided in the vertical tail 120 to control yawing of the flight vehicle.

The control unit 230 is realized, for example, by a processor such as a central processing unit (CPU) or a graphics processing unit (GPU) executing a program stored in the storage unit 206. In addition, the control unit 230 may be realized by hardware such as a large scale integration (LSI), an application specific integrated circuit (ASIC), or a field-programmable gate array (FPGA), and may be realized by cooperation of software and hardware.

### [Process Content of the Control Part]

### First Example of Control

Hereinafter, control content of the control unit 230 will be described. The control unit 230 drives the propeller 110 by controlling the propeller actuator 212 when the flight vehicle 100 is in a 90-degree pitch-up state. Thus, the flight vehicle 100 takes off like a tail-sitter type vertical takeoff and landing (VTOL) drone. The tail-sitter type is a flight type in which the flight vehicle 100 takes off from the 90-degree pitch-up state, returns the nose to a horizontal position at a certain altitude, and flies with the lift force generated by the wing.

Since such a tail-sitter type has a large attitude change, if ZYX Euler is used to calculate an attitude error, when the Z_{B} axis is plus or minus 90 degrees during takeoff and landing, it becomes a singular attitude and cannot be expressed. Further, in flight mimicking a bird, there is a high probability that a large attitude change will occur, and thus attitude expression without a singular attitude is necessary. To solve this problem, a quaternion is employed to calculate the attitude error. The quaternion is represented by Equation (1) using a three-dimensional unit vector r and a rotation angle ζ thereof.

$$[ Equation 1 ]$$

$$q = [ \begin{matrix}cos ( ζ / 2 ) \\ r sin ( ζ / 2 )\end{matrix} ] = {[ \begin{matrix}{q}_{0} & {q}_{1} & {q}_{2} & {q}_{3}\end{matrix} ]}^{T} \qquad ( 1 )$$

When it is assumed that qᵣ is a target attitude and q_{c} is a current attitude, a deviation qₑ between the target attitude and the current attitude is expressed by Equation (2) using a quaternion matrix.

$$[ Equation 2 ]$$

$${q}_{ρ} = [ \begin{matrix}{q}_{ro} & {q}_{r 1} & {q}_{r 2} & {q}_{r 3} \\ - {q}_{r 1} & {q}_{ro} & {q}_{r 3} & - {q}_{r 2} \\ - {q}_{r 2} & - {q}_{r 3} & {q}_{ro} & {q}_{r 1} \\ - {q}_{r 3} & {q}_{r 2} & - {q}_{r 1} & {q}_{ro}\end{matrix} ] {q}_{c} \qquad ( 2 )$$

The deviation qₑ indicates how much rotation should be done around which axis in a current fuselage-fixed coordinate system in order to bring the current attitude of the fuselage closer to the target attitude. For example, the control unit 230 performs feedback control by making a vector part of qₑ correspond to the fuselage-fixed coordinate X_{B}, Y_{B}, and Z_{B} axes.

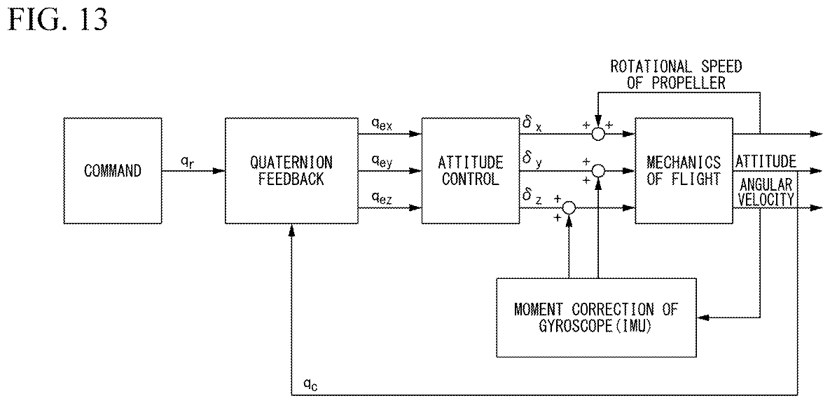

FIG. 13 is a diagram showing an example of an attitude control system using quaternion feedback. For example, the control unit 230 controls the twist actuator 216 to control the attitude of the flight vehicle 100 in the X_{B} axis. Also, the control unit 230 controls the elevator actuator 220 to control the attitude of the flight vehicle 100 in the Z_{B} axis. The control unit 230 also controls the rudder actuator 222 to control the attitude of the flight vehicle 100 in the Y_{B} axis.

The control unit 230 performs proportional-integral-differential controller (PID) control of the actuators corresponding to each of the axes. The PID control is represented by Equations (3) to (5).

$$[ Equation 3 ]$$

$${δ}_{x} = - ( {K}_{p} {q}_{ex} + {K}_{j} \int {q}_{ex} dt + {K}_{D} {\dot{q}}_{ex} ) \qquad ( 3 )$$

$$[ Equation 4 ]$$

$${δ}_{y} = - ( {K}_{p} {q}_{ey} + {K}_{D} {\dot{q}}_{ey} ) + {K}_{j} {ω}_{z} \qquad ( 4 )$$

$$[ Equation 5 ]$$

$${δ}_{z} = - ( {K}_{p} {q}_{ez} + {K}_{D} {\dot{q}}_{ez} ) + {K}_{j} {ω}_{y} \qquad ( 5 )$$

In Equations, δₓ represents a rudder angle of the twist, that is, a twist angle α_{twi}, δ_{y} represents a rudder angle of an elevator, and δ_{z} represents a rudder angle of a rudder. K_{P} represents a proportional gain, K_{I} represents an integral gain, and K_{D} represents a differential gain. Kⱼ is a gain for correcting a gyroscopic moment of the fuselage.

Correction terms (Kⱼω_{y}, Kⱼω_{z}) considering the influence of a propeller gyro effect are added to the third term on the right side for the control of the Y_{B} and Z_{B} axes. ω_{z} is a rotational speed of the fuselage around the Z_{B} axis. ω_{y} is the rotational speed of the fuselage around the Y_{B} axis.

For example, as shown in FIG. 13, the control unit 230 calculates the target attitude using an error distance between the current position and the target position of the flight vehicle 100. The control unit 230 controls the twist actuator 216, the elevator actuator 220, and the rudder actuator 222 and controls the attitude of the flight vehicle 100 based on the calculated target attitude. The target attitude may be instructed from an external device as a command.

### [Process Flow of Control Unit]

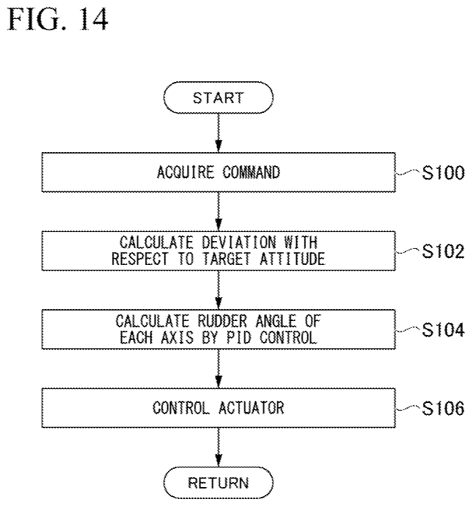

A flow of a series of processes of the control unit 230 will be described below using a flowchart. FIG. 14 is a flowchart showing a series of processes of the control unit 230. The processes of this flowchart may be performed repeatedly at a predetermined cycle, for example.

First, the control unit 230 acquires a command from an external device via the communication unit 202 (Step S100). The command includes, for example, an attitude that the flight vehicle 100 should take, that is, the target attitude qᵣ.

Next, the control unit 230 calculates the current attitude q_{c} of the flight vehicle 100 based on the detection result of the detection unit 204, and calculates the deviation qₑ between the calculated current attitude q_{c} and the target attitude qᵣ (Step S102). The deviation qₑ includes quaternions qₑₓ, _{ey}, and _{ez} corresponding to the fuselage-fixed coordinate X_{B}, Y_{B}, and Z_{B} axes.

Next, based on the calculated deviation qₑ, the control unit 230 calculates the rudder angle δₓ of the twist, the rudder angle δ_{y} of the elevator, and the rudder angle δ_{z} of the rudder as control variables by the PID control (Step S104).

Next, the control unit 230 sends control signals based on the calculated rudder angles δₓ, δ_{y}, δ_{z} to each of the actuators to control each of the actuators (Step S106). Thus, the processes of this flowchart end.

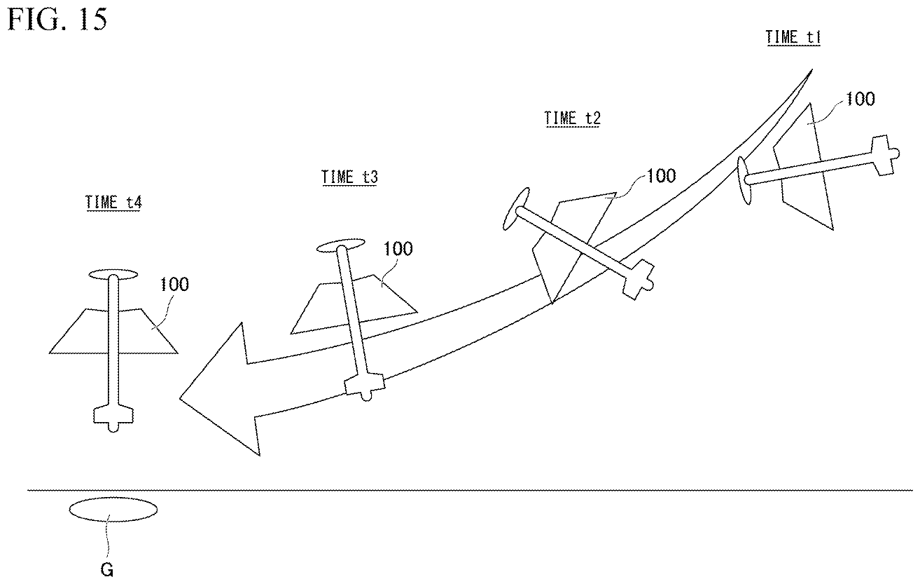

FIG. 15 is a diagram schematically showing a state in which the flight vehicle 100 flies. The example shown in the drawing shows a state when the flight vehicle 100, which is flying horizontally at a constant altitude, lands. G in the drawing is a target landing point. The landing point G may be a one-dimensional point, a two-dimensional surface, or a three-dimensional space.

For example, assuming that the communication unit 202 receives a command for landing the flight vehicle 100 from an external device at time t1, in this case, the control unit 230 controls the sweep actuator 214 to rotate the morphing wing 140 around the yaw axis Z_{B}, thereby moving the morphing wing 140 forward of the fuselage. Thus, the nose of the flight vehicle 100 rises. In addition, the control unit 230 controls the fold actuator 218 to further extend the morphing wing 140 in the direction of the pitch axis Y_{B}, thereby increasing the angle between the longitudinal directions of the plurality of flight feathers 160 and forming a gap. Also, the control unit 230 controls the elevator actuator 220 to raise the nose of the flight vehicle 100. Thus, the flight vehicle 100 transitions to the 90-degree pitch-up state while raising the fuselage at times t2, t3, and t4. As a result, the flight vehicle 100 can quickly decelerate because a drag force of the entire fuselage increases. Further, since a gap is formed between the flight feathers 160 during deceleration, stall can be curbed. When the flight vehicle 100 is in the pitch-up state, the control unit 230 controls the propeller actuator 212 to make the flight vehicle 100 descend to the landing point G while hovering.

According to the process content of the control unit described above, the angle between the flight feathers 160 of the morphing wing 140 is increased as the morphing wing 140 extends in the direction of the pitch axis Y_{B}. Thus, since the gap is formed between the flight feathers 160, the airflow can escape to the gap, and the stall can be curbed. As a result, the flight performance of the flight vehicle 100 can be improved.

Further, according to the above-described process content of the control unit, an amount of change in a wing area and a shape of the morphing wing 140 can be increased by further including a sweep mechanism that rotates the morphing wing 140 around the yaw axis Z_{B} and moves the morphing wing 140 in the forward and rearward direction of the fuselage, and a twist mechanism that rotates the morphing wing 140 around the pitch axis Y_{B} and rotates the morphing wing 140 inward and outward with respect to the flight vehicle 100 in addition to the link mechanism that expands and retracts the morphing wings 140 in the direction of the pitch axis Y_{B}. As a result, the change in the lift force and moment is increased, and the agility of the flight vehicle 100 can be improved.

The morphing wings 140 described above can perform the sweep, twist and fold operations symmetrically or asymmetrically. Further, the morphing wings 140 are also applicable not only to a flight structure application, but also to wind or tidal power blades and other structures that receive a force from a fluid.

### Second Example of Control

A second example of control will be described below. The second example of control is different from the first embodiment described above in that deep reinforcement learning is used to determine an amount of control for each of the sweep mechanism, the twist mechanism, and the link mechanism based on the attitude information, the speed, and the like of the flight vehicle 100. In the following, differences from the first embodiment will be mainly described, and description of points common to the first example of control will be omitted. In the explanation of the second example of control, the same parts as those in the first embodiment are given the same reference numerals.

One of the deep reinforcement learning includes, for example, a deep Q-network (DQN). The DQN is a method of learning an action value function Q (sₜ, aₜ), which represents a value when a certain action aₜ is selected under a certain state variable sₜ at a certain time t as a function, as an approximation function in a neural network in a reinforcement learning called Q-learning.

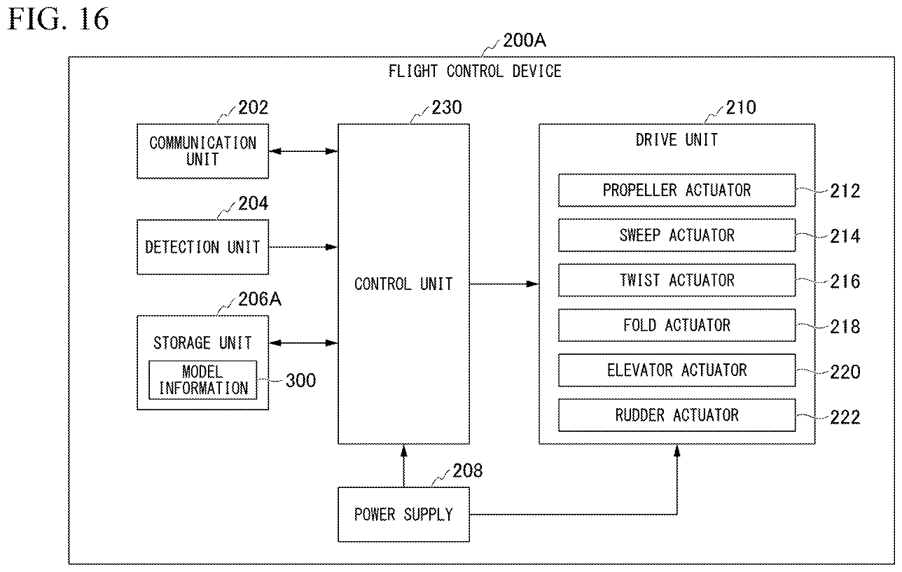

FIG. 16 is a diagram showing an example of a configuration of a flight control device 200A in the second example of control. In the flight control device 200A of the second example of control, model information 300 is stored in a storage unit 206A.

The model information 300 is information (a program or a data structure) that defines a model MDL learned by the Q-learning. The model MDL may be realized, for example, by a neural network including a plurality of convolutional layers and a fully connected layer that integrates output results of the plurality of convolutional layers.

The model information 300 includes, for example, connection information around how units included in each of an input layer, one or more hidden layers (intermediate layers), and an output layer that constitute each of the neural networks are connected to each other, or various types of information such as a coupling coefficient assigned to data input and output between the coupled units. The connection information includes, for example, information that identifies the number of units included in each of the layers, and a type of unit to which each of the units is connected, and information such as an activation function that realizes each of the units and a gate provided between the units of the hidden layers. The activation function that realizes the unit may be, for example, a normalized linear function (a ReLU function), a sigmoid function, a step function, or other functions. The gate selectively passes or weights data communicated between the units, for example, according to a value (for example, 1 or 0) returned by the activation function. The coupling coefficient includes, for example, a weight given to output data when data is output from a unit in a certain layer to a unit in a deeper layer in the hidden layers of the neural network. The coupling coefficient may also include an inherent bias component of each of the layers, and the like.

The model MDL is learned to output the action value function Q(sₜ, aₜ), for example, when a state variable sₜ is input.

The state variable sₜ is, for example, the current attitude q_{c} or the target attitude qᵣ of the flight vehicle 100 described above, or the deviation qₑ therebetween. Also, the state variable sₜ may include the speed of the flight vehicle 100 instead of or in addition to the attitude and the deviation. Further, when the detection unit 204 includes an optical fiber sensor that detects a deformation or a pressure sensor that detects the pressure, the state variable sₜ may include a deformation and a pressure that can be obtained from the sensors. The state variable sₜ including the deformation and the pressure is an example of “displacement information.”

The action aₜ is, for example, the amount of control of the sweep mechanism, the amount of control of the twist mechanism, the amount of control of the link mechanism, the rotational speed of the propeller 110, the rudder angle of the elevator, the rudder angle of the rudder, and the like. That is, the action aₜ is an amount of operation of each of the actuators of the drive unit 210. Also, the action aₜ may be a proportional gain KP, an integral gain KI, a differential gain KD, or a correction gain Kj of the PID control. Also, the action aₜ may be an index value indicating which of various controls such as PID control and hovering control is to be performed or not performed.

In the Q-learning, for example, the weight and bias of the model MDL are learned by increasing a reward when the morphing wings 140, the propeller 110, the elevator, and the rudder are in ideal states. For example, in the sky above the determined landing point G, the reward may be increased when the attitude of the flight vehicle 100 is in a 90-degree pitch-up attitude and the speed of the flight vehicle 100 is at a speed that can be regarded as stationary. On the other hand, the reward may be low (for example, zero) when the flight vehicle 100 is in contact with the ground or trees, or deviates from a determined altitude.

The control unit 230 inputs the current attitude q_{c} and the target attitude qᵣ of the flight vehicle 100 as state variables sₜ to the model MDL that has been learned so that a reward is given according to the action aₜ. The model MDL to which the state variables sₜ are input outputs an amount of operation of each of the actuators that tends to produce the highest reward as the action value function Q(sₜ, aₜ).

The control unit 230 causes the flight vehicle 100 to fly by controlling the actuators based on the amount of operation of each of the actuators output by the model MDL.

According to the second example of control described above, since each of the actuators is controlled using the model MDL that has learned in advance by the Q-learning, it is possible to approximate a flight method of a bird. As a result, the agility of the flight vehicle 100 can be further improved.

Further, according to the second example of control described above, in the flight action by the sweep mechanism, the twist mechanism and the link mechanism, although there is a large nonlinearity in the relationship between an input and movement as a response to the input, the model MDL can be learned so that it can output appropriate actions even in a nonlinear environment, and thus it is possible to adopt a flight method that was difficult with conventional control.

### Other Embodiments (Modified Examples)

Other embodiments (modified examples) will be described below. In the above-described embodiment, the flight vehicle 100 has been described as including the propeller 110, the vertical tail 120, the horizontal tail 130, the morphing wings 140, and the flight control device 200, but the present invention is not limited thereto. For example, the flight vehicle 100 may include only the propeller 110, the morphing wings 140, and the flight control device 200. In this case, the flight control device 200 may drive the twist mechanism to control the attitude of the roll axis X_{B} of the flight vehicle 100, or drive the sweep mechanism to control the attitude of the pitch axis Y_{B} of the flight vehicle 100.

As described above, according to the morphing wing 140 according to this embodiment, the front wing cover 180 and the flight feathers 160 are streamlined. Thus, the morphing wing 140 can have improved aerodynamic performance and more excellent flight performance. Further, when the link mechanism is retracted, the flight feathers 160 are retracted inside adjacent flight feathers 160. Thus, the size of the morphing wing 140 can be minimized when the link mechanism is retracted. Therefore, the transportability can be further improved.

Further, the flight feathers 160 are rotatably mounted on the primary link and the connecting member 156 or the front primary link 154 and the rear primary link, respectively. Since one flight feather 160 is mounted on two places in the link mechanism in this way, irregular movement of the flight feathers 160 can be restricted by the link mechanism, and the position and orientation of the flight feathers 160 can also be controlled by the link mechanism.

Further, the first front wing cover 181 provided on the primary link and the second front wing cover 182 provided on the second link 152 are included. Thus, the front wing cover 180 can follow the deployment and retraction of the link mechanism. Further, the third front wing cover 183 provided between the first front wing cover 181 and the second front wing cover 182 is provided. Thus, it is possible to prevent a gap from being formed in the front wing cover 180 when the link mechanism is deployed. Therefore, it is possible to prevent the airflow around the morphing wings 140 from being disturbed. Therefore, it is possible to contribute to improvement of the aerodynamic performance.

Further, when the link mechanism is deployed, an angle formed by the longitudinal directions of the adjacent flight feathers 160 in the primary arm-wing 160w is as large as that formed by the longitudinal directions of the flight feathers 160 located in the first direction. In other words, as the flight feathers 160 are located closer to the second direction side, the angle formed between the longitudinal directions of the adjacent flight feathers 160 becomes smaller. Thus, it is possible to prevent a decrease in the lift force caused by a gap between the flight feathers 160 on the second direction side.

In addition, for the flight feathers 160 located in the primary arm-wing 160w, as the flight feathers 160 are located closer to the first direction side, the angle between the longitudinal directions of the adjacent flight feathers 160 becomes larger. Therefore, the flight feathers 160 located at an end portion of the primary arm-wing 160w on the first direction side are located in a direction in which the longitudinal directions thereof face the first direction side and the transverse directions face from the front toward the rear. Thus, the overall size of the morphing wing in the deployed state can be increased.

Therefore, the lift force can be improved more.

In addition, the flight feathers 160 in the primary arm-wing 160w are configured so that an angle formed with the longitudinal directions of the adjacent flight feathers 160 connected via the connecting member 156 increases as the link mechanism is deployed. That is, when the link mechanism is retracted, an angle formed with the longitudinal directions of the adjacent flight feathers 160 decreases. Thus, when the link mechanism is retracted, the primary arm-wing 160w can be accommodated better. Therefore, it is possible to reduce the overall size of the morphing wing 140 when retracted, which contributes to the improvement of portability.

Further, when the link mechanism is deployed, the plurality of flight feathers 160 located at the end portion on the first direction side are streamlined from the front toward the rear. Therefore, the maximum lift force can be ensured for the morphing wing 140 in the deployed state. Furthermore, a gap is provided between the adjacent flight feathers 160. Thus, it is possible to curb the turbulence of the airflow generated at an end portion of the wing and to prevent the stall by allowing the airflow to escape through the gap. Therefore, it is possible to contribute to stable flight.

In addition, the plurality of flight feathers 160 located at the end portion on the first direction side are elastically deformed. Therefore, when the morphing wing 140 is deployed, they are deformed passively against a force exerted by the flow at the end portion of the morphing wing 140. Thus, it is possible to curb the turbulence in the airflow generated at the end portion of the wing. Therefore, it is possible to contribute to stable flight.

Also, when the flight vehicle 100 lands, the control unit 230 controls the drive unit 210 to extend the link mechanism in the first direction. Thus, it is possible to ensure the lift force of the flight vehicle 100 during landing and to contribute to stable landing.

In addition, the deep reinforcement learning is used for flight control. Thus, it is possible to perform flight more efficiently and safely by performing the flight control according to the environment of the flight site.

Further, displacement information including at least one of deformation and pressure of the morphing wing 140 is used for flight control. More agile control can be performed by acquiring the displacement information of the morphing wing 140 and performing the control before the attitude of the flight vehicle 100 changes. Therefore, it is possible to contribute to the improvement of mobility.

Further, when the flight vehicle 100 lands, the drive unit 210 that extends and retracts the link mechanism is controlled to extend the link mechanism. Thus, flying and landing closer to birds can be performed.

The technical scope of the present invention is not limited to the above embodiments, and various modifications can be made without departing from the scope of the present invention.

For example, the morphing wing 140 may be applied to any flying wing structure, such as a UAV or airliner.

The thrust device in the flight vehicle 100 is not limited to the propeller 110. For example, a jet engine or the like may be used.

Although it has been described that the flight feathers 160 in the secondary arm-wing 170w are located substantially parallel to the adjacent flight feathers 160, the present invention is not limited thereto. The flight feathers 160 in the secondary arm-wing 170w may have an angle with respect to the adjacent flight feathers 160 in the same manner as the primary arm-wing 160w, taking into account the positional relationship of the flight feathers 160 of the morphing wing 140 as a whole. In this case, it is preferable that the flight feathers 160 located closer to the second direction side are oriented closer to the forward and rearward direction.

In addition, it is possible to appropriately replace the constituent elements in the above-described embodiment with well-known constituent elements without departing from the spirit of the present invention, and the modified examples described above may be combined as appropriate.

### INDUSTRIAL APPLICABILITY

According to the present invention, a morphing wing structure with high flight performance can be provided.

### REFERENCE SIGNS LIST

100 Flight vehicle
140 Morphing wing
152 Secondary link
152a Front secondary link
152b Rear secondary link
154 Front primary link
160 Flight feather
160w Primary arm-wing
170w Secondary arm-wing
180 Front wing cover
181 First front wing cover
182 Second front wing cover
183 Third front wing cover
200 Flight control device
200A Flight control device
210 Drive unit
230 Control unit
MDL Model

1. A morphing wing comprising:
a link mechanism configured to be deployed in a first direction and retracted in a second direction opposite to the first direction;
a plurality of front wing covers mounted on a front side which is one side of the link mechanism perpendicular to the first direction; and
a plurality of flight feathers mounted on a rear side which is the other side of the link mechanism perpendicular to the first direction,
wherein the front wing covers and the flight feathers are streamlined from the front side toward the rear side, and
when the link mechanism is retracted, the flight feathers are retracted inside the adjacent flight feathers.

2. The morphing wing according to claim 1, wherein the link mechanism includes
a primary link including a front primary link mounted on the front side on the first direction side and a rear primary link mounted on the rear side on the first direction side, and
a secondary link including a front secondary link mounted on the front side on the second direction side and a rear secondary link mounted on the rear side on the second direction side, and
the plurality of flight feathers are rotatably mounted on the front primary link and the rear primary link or the front secondary link and the rear secondary link, respectively.

3. The morphing wing according to claim 2, wherein the front wing covers include
a first front wing cover provided on the primary link,
a second front wing cover provided on the secondary link, and
a third front wing cover provided between the first front wing cover and the second front wing cover.

4. The morphing wing according to claim 2, wherein the plurality of flight feathers include
a primary arm-wing mounted on the primary link and
a secondary arm-wing mounted on the secondary link, and
when the link mechanism is deployed, an angle formed between longitudinal directions of the adjacent flight feathers in the primary arm-wing is as large as that formed between longitudinal directions of the flight feathers located in the first direction.

5. The morphing wing according to claim 4, wherein the flight feathers in the primary arm-wing are configured so that an angle formed with the longitudinal directions of the adjacent flight feathers increases as the link mechanism is deployed.

6. The morphing wing according to claim 1, wherein, when the link mechanism is deployed, in the plurality of flight feathers located at an end portion on the first direction side, a transverse direction of each of the flight feather faces in a direction from the front side to the rear side, the transverse direction of each of the flight feathers is streamlined from the front side to the rear side, and a gap is provided between end portions of the rear side of the adjacent flight feathers.

7. The morphing wing according to claim 1, wherein the plurality of flight feathers located at the end portion on the first direction side are elastically deformed.

8. A flight control device which controls a flight vehicle including the morphing wing according to claim 1, comprising:
a drive unit configured to extend and retract the link mechanism; and
a control unit configured to control the drive unit,
wherein the control unit controls the drive unit to extend the link mechanism in the first direction when the flight vehicle lands.

9. The flight control device according to claim 8, wherein the control unit acquires attitude information representing an attitude of the flight vehicle and controls the drive unit based on an output result of a model obtained by inputting the acquired attitude information to the model learned using deep reinforcement learning.

10. The flight control device according to claim 9, wherein the control unit further acquires displacement information including at least one of deformation and pressure of the morphing wing and controls the drive unit based on an output result of the model obtained by inputting the acquired displacement information to the model.

11. A flight control method in which a flight control device that controls a flight vehicle having the morphing wing according to claim 1 controls a drive unit that extends and retracts the link mechanism to extend the link mechanism when the flight vehicle lands.

12. A program which causes a flight control device that controls a flight vehicle having the morphing wing according to claim 1 to extend the link mechanism by controlling a drive unit that extends and retracts the link mechanism when the flight vehicle lands.
